(19) United States
(12) Patent Application Publication
(10) Pub. No.: US 2007/0128335 A1
(43) Pub. Date: Jun. 7, 2007

(54) Methods and apparatus for continuous production of soy beans products

(75) Inventors: Hiroaki Iwamoto, Wakayama (JP); Koichi Gonda, Kanagawa (JP); Yuichi Wakabayashi, Kanagawa (JP)

Correspondence Address: MERCHANT & GOULD PC, P.O. BOX 2903, MINNEAPOLIS, MN, 55402-0903, US

(73) Assignee: SOIF Co., Ltd., Yokohama-shi (JP)

(21) Appl. No.: 10/588,251

(22) PCT Filed: Jan. 25, 2005
(86) PCT No.: PCT/JP05/00899

§ 371 Date: Aug. 2, 2006

(30) Foreign Application Priority Data
Feb. 3, 2004 (JP) 2004-26519

(51) Int. Cl. A23L 1/20

(52) U.S. Cl. 426/634

(57) ABSTRACT

[Problem] To produce soymilk and/or a soybean paste having excellent mouthfeel continuously. [Solution] A continuous production method of soybean products, wherein the soybean blend obtained by adding water to soybean powders and kneading is pressurized and stirred under fixed pressure to adjust its water content, the soybean solid component present in the soybean blend is smoothed and the pressure applied on the blend is released rapidly to atmospheric pressure. The smoothing of the soybean solid component present in the soybean blend can be carried out by passing the soybean blend through several fine pores provided in the flow path of the soybean blend.

### TECHNICAL FIELD

The invention relates to a continuous production method of soybean products including soymilk used as bean curd raw material and drinks, and a soybean paste suitable to use as raw material for the production of different food products comprising confectionary, ice cream, mixed products, etc., and to an apparatus therefor.

### BACKGROUND TECHNOLOGY

From the point of view of dietetics suggesting effective intake of fibrous food containing soybean and the point of view of reduction of waste matter as per environment protection guidelines, etc., the methods wherein complete soybean grains including husks are processed and soymilk is prepared with reducing the quantity of bean-curd refuses or practically without any bean-curd refuses have been proposed.

In such methods, the product obtained by soaking raw soybean in water, watering and grinding it into mashed soybeans and heating is processed in a high-pressure homogenizer to homogenize it and filtered through a filter having 20 to 15 μm pore diameter so as to obtain soymilk having smooth mouthfeel without any roughness. (For example, refer to Patent Publication 1). In the methods, it is preferable to carry out centrifugal filtration at 2500 to 3500 rpm using the filter having 20 to 15 μm pore diameter and a high-pressure homogenizer is operated at pressure 500 kg/cm².

The following reference can be given as a related art of the invention.

Patent Publication 1: Japanese Patent KOKAI (LOPI) No. 2002-17286

### DISCLOSURE OF THE INVENTION

### Problems to be Solved by the Invention

In the related art mentioned above, as the high-pressure homogenizer has to be operated at pressure 100 to 500 kg/cm², serious attention has to be paid to its safety and, as the centrifugal filtration is carried out using the filter having 20 to 15 μm pore diameter, the processing efficiency is poor. Therefore, essentially it is a batch processing and unsuitable for the mass production.

According to the related art, after homogenization process performed using the high-pressure homogenizer, a component of mashed soybeans having comparatively larger grain diameters are rejected through centrifugal filtration so as to obtain the soymilk having excellent mouthfeel. Therefore, the whole of the soybean is not used and bean-curd refuses are produced.

In view of the problems of the related art, the invention aims at providing a continuous production method of soybean products which enables not only the safe and continuous operation at comparatively low pressure and meets the requirement of mass production but also the production of soybean products having smooth and excellent mouthfeel and an apparatus therefor.

It also aims at providing a continuous production method of soybean products and an apparatus therefor of which the amount of bean-curd refuses are none, or little and yield rates are excellent even if the whole soybeans containing husks are used.

### MEANS TO SOLVE THE PROBLEM

To achieve the objective, in the present invention to provide a continuous production method of soybean products, the soybean blend obtained by adding water to soybean powder and kneading is pressurized and stirred under fixed pressure to adjust its water content, the soybean solid component present in the soybean blend is smoothed and pressure applied thereto is released; for example, the pressure is released to atmospheric pressure (Claim 1).

In this invention, the term “smoothing” refers to miniaturization and globulization of the soybean solid component present in the soybean blend. The globulization does not only mean simple to make the soybean solid component (solid particles) into globules but also make to angular parts of the solid particles round and provides almost globular shape to the whole particles present therein.

According to the invention, the pressure 50 kg/cm² or lower can be set for pressurizing the soybean blend (Claim 2).

It is preferable to stop to apply pressure to the soybean blend and releasing pressure to atmospheric pressure rapidly (Claim 3).

Smoothing of the soybean solid component present in the soybean blend can be carried out by passing the soybean blend through several fine pores provided in a flow path of the soybean blend (Claim 4).

Smoothing of the soybean solid component present in the soybean blend can be carried out together with ultrasonic processing (Claim 5). Moreover, the water used for watering the soybean powders and/or adjusting the water content of the soybean blend can be pretreated so as to make clusters of the water into fine particles (Claim 6).

In the method, the soymilk can be produced by adding almost an equivalent quantity of water to the soybean powders at the time of its watering then adding approximately 6 to 25 times of water content with respect to the quantity of soybean solid component in the soybean blend at the time of water content adjustment in the soybean blend and pressurizing the blend at the prescribed pressure of 5 to 50 kg/cm² (Claim 7). The resultant soymilk can be used for drinks. As well as the soymilk obtained by adding about 6 to 12 times of water with respect to the quantity of soybean solid component in the soybean blend at the time of water content adjustment in the soybean blend and then pressurizing it at the prescribed pressure 5 to 15 kg/cm² can be used for the production of bean curd (Claim 8).

A soybean paste can be produced by adding almost equivalent quantity of water to the soybean powder at the time of its watering then adding about 2 to 5 times of water with respect to the quantity of the soybean solid component in the soybean blend at the time of water content adjustment in the soybean blend and pressurizing it at prescribed pressure of 2 to 10 kg/cm² (Claim 8).

A continuous production apparatus of soybean products of this invention used for the realization of the method essentially comprises kneading means 20 and 30 for the kneading of watered soybean powders, a water content adjustment means 55 such as a water nozzle, etc., used for adjusting the water content in the soybean blend coming from the kneading means 20 and 30, a pressurization means 40 consisting of pump, etc., used for pressurizing the soybean blend after water-content adjustment at the prescribed pressure, processing systems 51, 60 and 70 used for stirring the pressurized soybean blend and smoothing of the soybean solid component in the soybean blend, and a pressure-releasing means 80 such as pressure valve, etc., used for releasing pressure of the soybean blend coming from the processing systems 51, 60 and 70 so as to release the pressure to the atmospheric pressure (Claim 9).

The processing systems have guiding blades 72 provided with multiple fine pores in the casing 71 and the structures such as guiding pipes 73 and 74 having circular or polygonal cross sections; the processing system can also be provided with a labyrinth device 70 for smoothing the soybean solid component present in the soybean blend by being passed through the fine pores provided in the structures (Claim 10).

In the kneading means, a screw device 20 and a roller device 30 arranged longitudinally (Claim 11) and the processing system can also be composed of a ultrasonic processing device 60 (Claim 12). Moreover, it can also be provided with a preprocessing device 56 for refining clusters of the water, used for watering the soybean powder and/or adjusting the water content of the soybean blend (Claim 13).

### EFFECT OF THE INVENTION

According to the continuous production method of soybean products of this invention, the soybean powder is watered and kneaded to pulverize the soybean solid component present in the soybean blend, the resultant product is pressurized so as to adjust the water content therein to the prescribed level and then the soybean blend is stirred to smooth the soybean solid component (solid particles) therein. Therefore, the solid particles are refined and uniformly rounded off, accordingly, a soybean product with excellent soft mouthfeel without any roughness is obtained.

That is, it became clear that to improve the mouthfeel of soymilk, a soybean paste and soybean processed foods produced by using them as ingredients, so that they provide smooth mouthfeel without any feeling of roughness, it is not enough to simply reduce the size of the solid particles therein, i.e., it is important to make an external shape of each solid particle round. Even if grain diameter of the rounded solid component particles are apparently increased due to aggregation thereof, the resultant food provides excellent smooth mouthfeel without little feeling of roughness.

In the method of this invention, the soybean solid component (solid particles) present in the soybean blend is not only refined but the particles thereof are also made round by the smoothing treatment. Therefore, it becomes possible to obtain excellent mouthfeel of the food as mentioned above. The grain diameters of the soybean solid component are reduced to a limit which is possible to make them fine and round. For example, the particle size of the soybean solid component (solid particles) in the soymilk and the soybean paste produced by the method of this invention, as determined by carrying out the analysis as shown in FIG. 6, is that a range of grain diameters are 0.5 μm to 100 μm and mean grain diameter become 9.777 μm.

It is recognized that, on the preparation of soybean paste, the grain diameter is large but the material is smoothed.

Smoothing treatment of the soybean solid component (solid particles) present in the soybean blend can be carried out by passing the soybean blend through multiple fine pores provided in the flow path of the soybean blend. To carry out the smoothing treatment, a labyrinth device 70 fixed to structures such as guide blades 72 provided with multiple fine pores, the guide pipes 73 and 74, etc. in the casing 71 can be used. During the processing, in the flow path, actions such as collision, shearing, confluence, parting, etc., repeatedly occurred upon the fluid which is the soybean blend. Therefore, the soybean solid component (solid particles) present in the fluid is not simply refined but external shape of each solid particle present therein is also rounded.

When the soybean blend passes through the labyrinth device 70, cloudy stream is generated and polishing of the solid particles is promoted. That is, when a conventional apparatus such as homogenizer, etc., is used, coagulation reaction by a coagulant used for mass production of soybean curd is considerably impaired by the modification of proteins due to high pressure, accordingly, a conventional bean curd having excellent mouthfeel can not be obtained. Therefore, in the apparatus of this invention, multiple units for causing repeated collision, polishing, etc., are provided at short distances in the piping so as to refine the particles and make them round.

In the labyrinth device 70, the other actions, for example, produced by cavitation (shock wave) and high frequency/ultrasonic wave are applied on the fluid comprising the soybean blend.

In the method of this invention, the pressure applied on the soybean blend can be reduced to or below 50 kg/cm². According to the invention, as excellent mouthfeel of the resultant food can be obtained by making each particle of the soybean solid component round, carrying out refining under low pressure even without precise refinement is one of the reasons. Therefore, the new apparatus can be safely operated applying comparatively low pressure without the problems faced while running a conventional apparatus applying high pressure as disclosed in the Patent Publication 1. Moreover, as the smoothing treatment system with large hole diameter can be easily made, the whole steps of this invention becomes continuous steps, accordingly, the present invention can easily meet the requirement of continuous method for mass production.

According to this invention, refining and rounding of particles can be carried out by the water permeation acceleration function due to effect of the ultrasonic device at low pressure and actions of the collision, polishing and interfusion occurred when the flow path of the blend through the labyrinth device.

In the method of this invention, as better mouthfeel of the food product can be obtained by refining the soybean solid component and making each particle present therein round even without precise refinement in comparison to that of the food obtained by using a high-pressure homogenizer, etc., it does not require the process of filtering a solid component particles having large grain diameters which is required in Patent Reference 1. Therefore, the whole of the soybeans as a raw material can be used without the production of bean-curd refuses and workability of the method is excellent. Moreover, as the filtration process is not required, the new method, coupled with the operation of an apparatus with the application of low pressure only, is suitable for the continuous mass production.

As soybeans which are ingredients of the products are hard, particles having acute angles are left even when they are mashed. Roughness in the food obtained from the soybean powder due to the presence of particles having acute angles in it can be considered that the cause of inability to bring the desired improvement therein. When examining the particles by using electron microscope with the magnifying power 500 to 3500, the presence of the state wherein particles having acute angles which are characteristics of pulverized soybean powder are overlapped each other can often be recognized.

If roughness remains even after refinement, a filtration step is required. However, the particles are rounded by being passed through the labyrinth device and ultrasonic device to make them round so as to easily slip through the throat, the filtration step is not required.

Therefore, depending on the grinding conditions of the soybean powder used as raw material, the filtration step can also be incorporated in the system.

When the soybean blend containing the smoothed soybean solid component (solid particles) is rapidly pressure-released to the atmospheric pressure, the solid component particles are swelled and dispersed rapidly due to lowering of the pressure as a result of which refinement of the particles is further accelerated.

If ultrasonic processing is used together with the smoothing treatment of the soybean solid component (solid particles), the residual air in particles of the soybean powders can be released by impact caused by the ultrasonic device and the permeation of water therein can be quickly accelerated. If water is already permeated into the particles, the water containing nutrient can be released and replaced instantaneously by fresh water repeatedly. The processing is aimed at releasing the water-soluble components.

In this invention, as the water used for watering the soybean powder and adjusting water content in the soybean blend is pretreated to refine its clusters, its permeation into the soybean solid component (solid particles) becomes still easier. Therefore, the release of air and extraction efficiency of the nutrition components improve and usability (yield rates) of the soybean powder increases.

The soybean products such as a soybean paste, soymilk for the production of bean curd and drinks, etc., can be produced in accordance with their application by adjusting the quantity of water added to the soybean blend at the time of adjusting its water content and pressure at the time of pressurization.

The soybean paste produced in this manner can be used in different types of food products; for example, as ingredients for the production of various types of confectionary such as ice cream, pudding, etc., thickener of the foods requiring thickening such as curry, soup, jam, etc., as quality improving agent for bread and various types of noodles such as pasta, macaroni, UDON (Japanese wheat noodle), Chinese noodles, etc., hamburger, GYOZA (Chinese Dumplings), marine fish paste, etc., the food products requiring the prevention of water separation therein, etc., as emulsifier of emulsified foods such as mayonnaise, dressing, etc.

The soybean paste can be used as filler of confectionary, ice cream, fish paste, etc., and also of noodles such as pasta, macaroni, UDON, Chinese noodles, etc.

The continuous production method of soybean products of the invention can be easily executed by using a continuous production apparatus therefor by combining kneading devices 20 and 30; a water content adjusting device 55 such as a water nozzle, etc.; a pressurization device 40 such as a pump, etc.; processing systems 51, 60 and 70 used for smoothing; and a pressure releasing device 80 such as a pressure valve, etc.

In the processing systems, appropriate smoothing of the soybean solid component (solid particles) present in the soybean blend for refining and making them round uniformly, can be carried out by using the labyrinth device 70 in which the structures 72, 73 and 74 provided with multiple fine pores in the casing are fixed.

As the screw device 20 and the roller device 30 are placed in continuity longitudinally in the kneading device, the former performs pre-kneading and the latter kneading and the whole kneading step is perfected.

Smoothing of the soybean solid component present in the soybean blend can be further accelerated by equipping the processing systems with the ultrasonic processing device 60 and the preprocessing means 56 for refining clusters of the water used in the kneading devices 20 and 30 and/or in the water adjusting device 55.

### PREFERRED EMBODIMENTS OF THE INVENTION

The preferred embodiments of the invention will be explained below with reference to attached drawings.

[Continuous Production Method of Soybean Products]

In a continuous production method of soybean products of the invention, as mentioned above, the soybean blend obtained by adding water to soybean powders and kneading them is adjusted its water content and pressurized under the prescribed pressure and stirred, the soybean solid component present in the soybean blend is smoothed, and pressure of the blend is released to atmospheric pressure; the method is used for the production of soybean products such as soymilk and a soybean paste.

According to the invention, the soybean powder with or without husks can be used; the powder obtained by grinding at least to the particle size 500 μm or lower, preferably 200 to 400 μm or lower is used.

The soybean powders can be produced by grinding and classification steps wherein raw soybeans are dried and their husks are removed or classified using a stone mill, a pin mill, a wind pressure, etc.

The soybean powder can be produced, for example, by soaking soybeans in water then steaming, grinding the mashed soybeans obtained by grinding raw or dry soybeans as such after drying.

At the time of watering the soybean powder for kneading, it is desirable to limit the quantity of water equivalent to that of the soybean powder. If excessive quantity of water is added, balls of soybean powder may be formed in its blend, all the more the kneading may be incomplete and coarse solid particles may be left therein.

For example, weight ratio of the soybean powders to the water for watering is 1:1 to 4.

The quantity of water to be added at the time of adjusting the water content in the soybean blend (obtained by kneading) before pressurizing it varies depending on whether soymilk for drinks or soymilk for the production of bean curd or a soybean paste used as filler, etc., is to be produced. Preferably the quantity of the water to be add, with respect to the soybean solid component in the soybean blend is 6 to 25 times, 6 to 12 times and 2 to 5 times of water, at weight ratio respectively.

It is desirable to refine beforehand clusters of the water to be used at the time of pressurization and water content adjustment by carrying out its preprocessing so as to make permeation of water into the soybean solid component suitably.

The pressure to be fixed at the time of pressurization of the soybean blend obtained after water content adjustment also varies depending on the soybean product to be produced. For the production of soymilk for drinks, soymilk for the production of bean curd, and soybean paste used as filler, it can be fixed at 5 to 50 kg/cm², 5 to 15 kg/cm² and 2 to 10 kg/cm² respectively. As even the maximum pressure to be applied in the method of this invention is comparatively low, i.e., 50 kg/cm² or lower, the next processing system used for smoothing treatment can be easily prepared with large hole diameter and the whole process can be used as a continuous production method meeting the requirement of mass production.

After stirring the pressurized soybean blend, its smoothing treatment can be carried out by passing it through multiple fine pores provided in the flow path of the soybean blend. During the processing, in the flow path, collision, shearing, confluence, parting, etc., repeatedly act on the soybean solid component (solid particles) of the fluid comprising the soybean blend. Therefore, the soybean solid component (solid particles) present in the fluid is not simply refined but external shape of each solid particle present therein is also rounded as a result of which softness and mouthfeel of the resultant soybean food are improved.

A system comprising the labyrinth device 70 through which the fluid consisting of the soybean blend is passed with being wound its flow path and the actions such as collision, shearing, confluence, parting, etc., can be realized repeatedly, with the help of the guiding blades 72 made of punching metal having multiple fine pores and the circular or triangular cylinder bodies (guide pipes) 73 and 74, similar to Mu-mixer and Mu-reactor of the Mu-Company, Ltd., a muffler used in internal combustion engine, etc., can be given as an example of the processing system used smoothing treatment. When soybean blend is passed through the labyrinth device 70, the soybean solid component (solid particles) present in it is smoothed thereby the solid component particles present therein are refined and uniformly rounded off. The above-mentioned fine pores can be round or elliptical or can have such pore diameter that the soybean solid particles present in the soybean blend are refined and rounded to the desired size and shape.

Concerning the labyrinth device shown in FIG. 3 (A) to (D), any shapes, thickness, locations, directions, materials, etc., can be adopted if shearing, collision, polishing, interfusion, etc., is repeatedly generated at short distances within the piping. The labyrinth device capable of handling the change of concentration due to the variation of quantity of water added therein can also be used.

In the smoothing treatment systems, the permeation of water into the soybean solid component present in the soybean blend may be promoted by releasing air and extracting nutrition component from it with utilizing the ultrasonic processing device.

Pressure in the soybean blend after subjecting the smoothing treatment can be released from the pressurized state at the prescribed pressure to the atmospheric pressure. It is desirable to release pressure rapidly by using the pressure valve, etc.; it further promotes the refinement of the soybean solid component (solid particles) present in the soybean blend and improves mouthfeel of the resultant food.

[Continuous Production Apparatus of Soybean Products]

A continuous production apparatus of soybean products of this invention used for the realization of the above-mentioned method essentially comprises kneading means 20 and 30 for the kneading of watered soybean powder, a water content adjustment means 55 used for adjusting the water content in the soybean blend coming from the kneading means 20 and 30, a pressurization means 40 used for pressurizing the soybean blend after water-content adjustment at the prescribed pressure, processing systems 51, 60 and 70 used for stirring the pressurized soybean blend and smoothing of the soybean solid component in the soybean blend, and a pressure releasing means 80 used for pressure releasing of the soybean blend coming from the processing systems 51, 60 and 70 so as to bring it to the atmospheric pressure. The apparatus of this invention is also equipped with a screw device 20 and a roller device 30 for kneading, the pump 40 for pressurization, static mixers 51, 51 for stirring, the ultrasonic processing device 60, the labyrinth devices 70 and 70 and the pressure valve 80 for releasing pressure (FIG. 1).

A feeding device 10 for feeding a fixed quantity of the soybean powder used as raw material is provided at a front step of the screw device 20.

The screw device 20 and the roller device 30 placed next to it longitudinally form the kneading means used for watering the soybean powder coming from the feeding device 10 with the help of the water nozzles 53 and 54 and kneading them; together with the static mixers 51, 51, the ultrasonic processing device 60, the labyrinth devices 70 and 70, and a reservoir pipe 52 extended up to the pressure valve 80, they form the processing system for smoothing of the soybean solid component present in the soybean blend by stirring the fluid comprising the pressurized soybean blend.

(1) Feeding Means

The feeding device 10 is provided with a hopper 11 for feeding the soybean powders used as raw material and a screw conveyor 12 for feeding a fixed quantity of the soybean powder from the hopper 11 to the next screw device 20. The screw conveyor 12 is driven by a driving motor 21a.

(2) Kneading Means

In this embodiment, the kneading means used for kneading of watered soybean powder comprises the screw device 20 and the roller device 30.

(2-1) Screw Device

The screw device 20 is provided with a kneading screw 22 in bottom of a kneading chamber 21. The kneading screw 22 is driven together with a pump 23 used for feeding by a common driving motor 22a; it performs kneading of the soybean powder fed by the feeding device 10 with adding water supplied through a water nozzle 53 thereto and feeds the kneaded blend to the next roller device 30 through the pump 23.

(2-2) Roller Device

The roller device 30 is equipped with kneading rollers 31 and 31 provided with scrapers 31a and 31a in an upper part of a kneading chamber 32. The kneading rollers 31 and 31 are driven by a common driving motor 31b. The roller device 30 performs kneading of the soybean blend supplied from the screw device 20 with adding water coming from water nozzles 54 and 54 located on upper portions of the kneading rollers 31 and 31, adjusts water content therein by adding water coming from water nozzles 55 and 55 located in lower parts of the kneading rollers 31 and 31, and the soybean blend can be supplied after water adjustment therein to a pump 40 located next and used for pressurization.

In the apparatus of this invention, the screw device 20 and the roller device 30 are used as the kneading means. Nevertheless, any other configuration capable of suitably watering and kneading the soybean powder and adjusting its water content can be used.

(3) Water Supply Systems

The water supply systems are used for supplying water required for watering the soybean powder for its kneading in the kneading means and for adjusting the water content in the soybean blend produced after kneading by the kneading means 20 and 30. In this embodiment, the water required for watering and water content adjustment is supplied to the screw device 20 and the roller device 30 from a common source of water supply. The water supplied from the water supply source is distributed into the water nozzles 53, 54 and 54 used for watering at the time of kneading through a ultrasonic processing device 56 and water supply pump 57 and into water nozzles 53a, 54a and 55a forming a water content adjustment means composed of water nozzles 55, 55. Each water nozzle 53, 54 and 55 is connected to the release side of the water supply pump 57 through flow rate adjusting valves 53a, 54a and 55a and switch valves 57a and 57a.

The ultrasonic processing device 56 is used as a preprocessing device for refining water clusters and a high magnetic field generating device can also be used as the preprocessing device. If the water having very small clusters such as deep sea water is used, the processing device 56 can be omitted.

Any other configuration capable of watering the soybean powders to the desired level and adjusting the water content therein can also be used.

It is desirable to heat the water supplied to the water nozzles 53, 54 and 55 to a temperature of 55 to 65° C. using a heating device (not shown in the figure). Because it increases permeation of water in the temperature into the soybean powder increased and extraction of the nutrition component is improved.

(4) Pump

The pump 40 is used for pressurizing the soybean blend at the specified pressure. The pump of any configuration capable of functioning as pressurizing device can be used. For example, a mohno pump produced by HEISHIN Ltd., etc., can be used. It can be driven by a driving motor 41 and used for pressurizing and feeding the soybean blend as fluid with adjusted water content therein at the maximum pressure of 50 kg/cm².

(5) Processing System

The processing system comprising static mixers 51 and 51, the ultrasonic processing device 60, the labyrinth devices 70 and 70, and the reservoir pipe 52 equipped with a drain valve 52a is provided on a release side of the pump 40. The soybean blend pressurized by the pump 40 and supplied to the processing device is stirred in the static systems 51 and 51 and the soybean solid component present in the blend is smoothed mainly in the labyrinth devices 70 and 70. The ultrasonic processing device 60 is provided for promoting the smoothing treatment and the reservoir pipe 52 for swelling the solid component particles after the smoothing treatment. The static mixers 51 and 51 can be of any types and 1 or 2 or more steps can be used. The reservoir pipe 52 can be provided depending on the requirement.

(5-1) Ultrasonic Processing Device

An example of the ultrasonic processing device 60 is given in FIG. 2. FIG. 2 (A) shows a side view of a casing 61, FIG. 2 (B) shows a whole lateral sectional view, and FIG. 2 (C) shows a side view of the vibrating plate 62 loaded with ultrasonic generators 63, 63 . . . .

The casing 61 is formed into a regular pentagonal pipe tapered at both ends and connecting flanges 61a and 61a are provided at both ends of the casing. Rectangular openings 61b are formed on each side of the casing 61 and a frame-shaped flange 61c is provided around the respective openings 61b.

The ultrasonic generators 63, 63 . . . are arranged serially on the vibrating plates 62 adjusted to openings 61b. Each vibrating plate 62 is screwed on a flange 61c through a packing 62a and a holding frame 62b. A protecting cover 62c is also attached on the holding frame 62b.

The ultrasonic processing device 60 having the above-mentioned configuration can treat the fluid passing through the casing 61 in axial direction by simultaneously exciting all the ultrasonic generators 63, 63 . . . located above the casing 61 in the same phase. As the ultrasonic generators 63, 63 . . . are arranged on each side face of the pentagonal casing 61, during the step, there is no chance of the ultrasonic vibrations being negated mutually within the fluid.

In this embodiment, the ultrasonic processing device 60 having the above-mentioned configuration has been used. Nevertheless, any known ultrasonic processing device capable of generating ultrasonic waves of desired state can be used.

(5-2) Labyrinth Device

The labyrinth device 70 is used for smoothing the soybean solid component present in the soybean blend, wherein the soybean particles are refined and uniformly rounded off. In this embodiment, the structures having multiple fine pores in the casing 71 are fixed in such a manner that the soybean blend passes through fine pores of the structures. For example, a device of the Mu mixer or Mu reactor type, wherein multiple guiding blades 72, 72 . . . made of punching metal into fan shape and fixed at apex of the casing 71 and arranged like windmills by twisting the respective guiding blades 72, 72 . . . in the same direction constitute a single set and several such sets are fixed with a specified interval in between the two successive sets longitudinally in the casing 71 (FIG. 3 (A)), a device wherein stationary guiding blade 72 provided with 1 punching metal plate twisted in spiral form is used (FIG. 3 (B)), a device wherein regular triangular guide pipes 73 made of punching metal are fixed twisting in an axial direction in the casing 71 (FIG. 3 (C)), a muffler type device provided with cylindrical guide pipes 74 and 74 of different lengths made of punching metal and perforated baffle plates 75 and 75 (FIG. 3 (D)), etc., may be used.

In the labyrinth device 70 shown in FIG. 3(D), the direction of flow inside the casing 71 can be reversed 2 times or more by providing the combination of 3 or more guide pipes 74, 74 . . . and 3 or more baffle plates 75, 75, . . . or an inlet and an outlet can be opened at both ends of the casing 71. In the labyrinth devices (A) to (C), it is desirable to use multiple devices, wherein the guiding bladed 72 or the guide pipes 73 are laid by putting one upon another or twisted reciprocally in opposite directions, arranged longitudinally. Either one type of the labyrinth devices 70 shown in FIG. 3 (A) to (D) or combination thereof can be used (FIG. 1).

By using the labyrinth device 70 equipped with the different types of structures such as the guiding blades 72 provided with fine pores, guide pipes 73, 74, etc., the actions such as collision, shearing, confluence, parting, etc., can be applied on the fluid comprising the soybean blend and the solid particles present in the blend can be suitably refined and uniformly rounded off.

(6) Pressure Valve (Pressure Releasing Device)

The pressure valve 80 is used for releasing pressure in the soybean blend pressurized at the set pressure. It is constituted by placing a valve seat 81 and a valve body 82 in a valve box 83 (FIG. 4).

Outside the valve box 83, the valve body 82 is energized in the closing direction through a compression spring 84 which presses a valve rod 82a. By setting compressive strength of the compression spring 84, the fluid (soybean blend) at or above the set pressure can be pressure-released rapidly with the help of the pressure valve 80. The set pressure can be regulated through a holding clasp 84a screwed at one end of the compression spring 84 and the holding clasp 84a can be locked through a lock nut 84b.

Flanges 83a and 83b are provided on inlet and outlet sides of the valve box 83. A narrow groove 82b is formed spirally in the valve body 82 for the leakage.

According to this invention, any known device other than the pressure valve 80 can be used provided it is equipped with the mechanism which is capable of releasing pressure of the soybean blend exerted by the pressurization device.

(7) Heating Device

A heating device can also be provided on output side of the valve 80 so as to heat the soybean blend for 1 to 3 minutes by boiling. The desired soybean product such as soymilk or soybean paste can be obtained by using the heating device.

Processing processes of the continuous production apparatus shown in FIG. 1 can be summarized with the help of the flowchart given in FIG. 5. That is, soybean powder is watered and kneaded in 2 stages by the kneading device composed of the screw device 20 and the roller device 30. After the adjustment of water content therein, the resultant blend is pressurized through the pump 40, stirred through the static mixers 51 and 51, the solid component present in the soybean blend is smoothed through the ultrasonic processing device 60, the labyrinth devices 70 and 70 and the reservoir pipe 52, its pressure is released through the pressure valve 80 and at this point it is rapidly pressure-released to the atmospheric pressure. The water can be pretreated with the help of the ultrasonic processing device 56 and then used for watering the soybean powder and water content adjustment therein feeding through the water nozzles 53, 54 and 55. The ultrasonic processing device 56 can be of the same type as the ultrasonic processing device 60 used in the processing system of soybean blend, or of a different type.

[Soybean Products]

The soymilk and soybean paste produced by the method and apparatus of this invention can be used as soymilk for drinks and an ingredient, a filler, a thickener, an emulsifier, etc., for the production of different types of food. Moreover, the soymilk and soybean paste capable of being preserved by refrigeration without any change in their mouthfeel and flavor even on thawing after refrigeration and the soymilk and soybean paste resistant to high temperature retort without any change in the mouthfeel and flavor even on heating to about 120° C. can be obtained by adding to them suitable quantity of 1 or more additives selected from the group comprising starch-based thickening polysaccharides, mucopolysaccharides, natural rubber-based polysaccharides, etc.

If the soybean powders including husks are used in the method and apparatus of this invention, a process for separating soybean solid components by using a decanter type centrifugal separator can also be added after the heating process shown in FIG. 1.

The soybean paste produced by the method and apparatus of this invention can be used in confectionary, ice cream, mixed prodfish cakesucts, etc., and in other foods such as pasta, macaroni, UDON, Chinese noodles, etc. It can be suitably used in the foods containing wheat flour as the main component such as bread, pasta, etc., particularly after dry grinding processing.

That is, the soybean paste produced by the method and apparatus of this invention can be used for the production of various types of soybean foods, for example, as raw material and a filler in various types of confectionary such as ice cream, custard pudding, etc., bread, noodles such as pasta, macaroni, UDON, Chinese noodles, etc., hamburger, GYOZA, fish cakes, etc., as a thickener in curry, soup, jam, etc., and an emulsifier in mayonnaise, dressing, etc.

The soymilk used as raw material of bean curd can be used for the production of common KINUGOSHI TOFU (soft bean curd) and MOMEN TOFU (hard bean curd) by mixing with soymilk coagulants such as calcium sulfate, bittern, gluconodeltalactone, etc., and then carrying out coagulation by maturing it. Moreover, it can also be used for the production of the bean curd capable of being preserved by refrigeration maintaining its structure even on thawing by quickly mixing with soymilk not only a coagulant but also a gelling agent capable of producing the gelation and coagulating effect therein and then carrying out coagulation by maturing it.

The gelling agents include proteins such as gelatin, casein, etc.; seaweed polysaccharides such as agar, carragreenan, etc.; plant polysaccharides such as tamarind gum, gum Arabic, guar gum, etc.; thickening polysaccharides, mucopolysaccharides, natural rubber-based polysaccharides, etc. The gelling agents can be used individually or in combination of 2 or more of them.

Specific example of the starch-based thickening polysaccharide is a thickening processing agent derived from yam belonging to Dioscoreacea. Examples of the yam belonging to Dioscoreacea are yam, Japanese yam, Chinese yam, ICHINEN IMO, ICHYO IMO, ISE IMO, YAMATO IMO, etc. They can be added in a powder form or in a solution form.

A thickening heat processing agent derived from cheese whey can also be added with respect to 100 wt % of the soymilk as thickening agent. An example of the thickening heat processing agent derived from cheese whey is the whey protein obtained from a byproduct (also called sweet whey) formed during the manufacture of cheese from raw milk such as cow's milk, etc.

A shape loss preventing agent derived from animal protein, for example, the whey protein obtained from a byproduct (also called acid whey) during the manufacture of casein or cottage cheese from raw milk such as cow's milk, etc., can also be used therein.

For the production of bean curd similar to OBORO TOFU, which exhibits soft mouthfeel without any feeling of granular matter mixed therein and can be preserved by refrigeration, from the soymilk manufactured by the method and apparatus of this invention as an ingredient, for example, as weight of solid component in dry state, 0.01 to 0.08 wt %, preferably 0.05 to 0.3 wt % or lower of a coagulant, 0.05 to 4 wt %, preferably 0.1 to 2 wt % of gelatin, 0.01 to 4 wt %, preferably 0.04 to 2 wt % of the thickening processing agent derived from yam belonging to Dioscoreacea, 0.01 to 4 wt %, preferably 0.04 to 2 wt % of the thickening heat processing agent derived from cheese whey, and 0.01 to 3 wt %, preferably 0.03 to 2 wt % of the shape loss preventing agent derived from an animal protein with respect to 100 wt % of the soymilk liquid can be added.

For the production of bean curd with reduced water content capable of being preserved by refrigeration and exhibiting harder mouthfeel in comparison to an ordinary bean curd, for example, as weight of solid component in dry state, 0.3 to 0.8 wt %, preferably 0.4 to 0.6 wt % of a soymilk coagulant, 0.05 to 4 wt %, preferably 0.1 to 2 wt % of gelatin as gelling agent, 0.1 to 3 wt %, preferably 0.5 to 2 wt % of the thickening processing agent derived from yam belonging to Dioscoreacea, 0.5 to 15 wt %, preferably 1 to 8 wt % of the thickening heat processing agent derived from cheese whey, and 0.5 to 5 wt %, preferably 1 to 3 wt % of the shape loss preventing agent derived from an animal protein with respect to 100 wt % of the soymilk liquid can be added.

### EMBODIMENTS

Distribution data of solid particles in the soybean paste produced through all the treatment processes shown in FIG. 5 using continuous production apparatus of this embodiment shown in FIG. 1 is shown in FIGS. 6 and 7. The soybean paste of the embodiment was produced by adding the pretreated water to the whole soybean powders for adjusting its water content so that the mixing ration of the soybean powders to water become 1:4 and carrying out the subsequent processing at pressure 7 kg/cm² adjusted with the help of the pump 40 and the pressure valve 80.

The distribution data of solid particles in 3 soybean paste samples obtained by using 1 wt % of the whole soybean, mixing 4 wt % of untreated water or the pretreated with it and then thoroughly stirring in a propeller type mixer is shown in FIG. 6 as comparative examples (1) to (3). Detailed particle distribution data of the soybean paste of the embodiment of this invention is shown in FIG. 7.

The particle size distribution data shown in FIG. 6 was obtained by using the Shimazu laser diffraction particle distribution measuring instrument SALD-3100. The data of particle size distribution shown in FIG. 7 was obtained by examining the soybean paste after diluting it 50 times.

It is clear from the data shown in FIG. 6 that median size of the solid particles in the samples of the comparative examples (1) to (3) is 31.0 to 33.7 μm while that of the solid particles in the sample of the embodiment is 105.4 μm. Nevertheless, it is clear from FIG. 7 that each individual solid particle in the sample of the embodiment is extremely fine and round, but the particles present therein aggregate to form the particles of apparently large median diameter.

Moreover, the samples of the comparative examples (1) to (3) exhibited bad mouthfeel and any feeling of roughness. On the other hand, the sample of the embodiment exhibited excellent smooth mouthfeel without any feeling of roughness.

An example of the mouthfeel evaluation test data of the soybean paste samples of the comparative examples (1) to (3) and the embodiment is given in FIG. 8. As compared to the comparative examples (1) to (3), the comparative example (4) was executed by combining therein the use of the processing carried out with the help of the ultrasonic processing device 60 and, as compared to the comparative example (4), the comparative example (5) was executed by adding therein the smoothing treatment carried out with the help of the muffler type labyrinth device 70, but carrying out the natural release through outlet of the labyrinth device 70 instead of rapidly pressure releasing by the pressure valve 80. Sample of the comparative example (5) also exhibited almost satisfactory mouthfeel but the sample of the embodiment exhibited excellent mouthfeel.

### BRIEF DESCRIPTION OF THE DRAWINGS

FIG. 1 shows a schematic system diagram of the entire configuration showing execution mode of the production apparatus of soybean products of this invention.

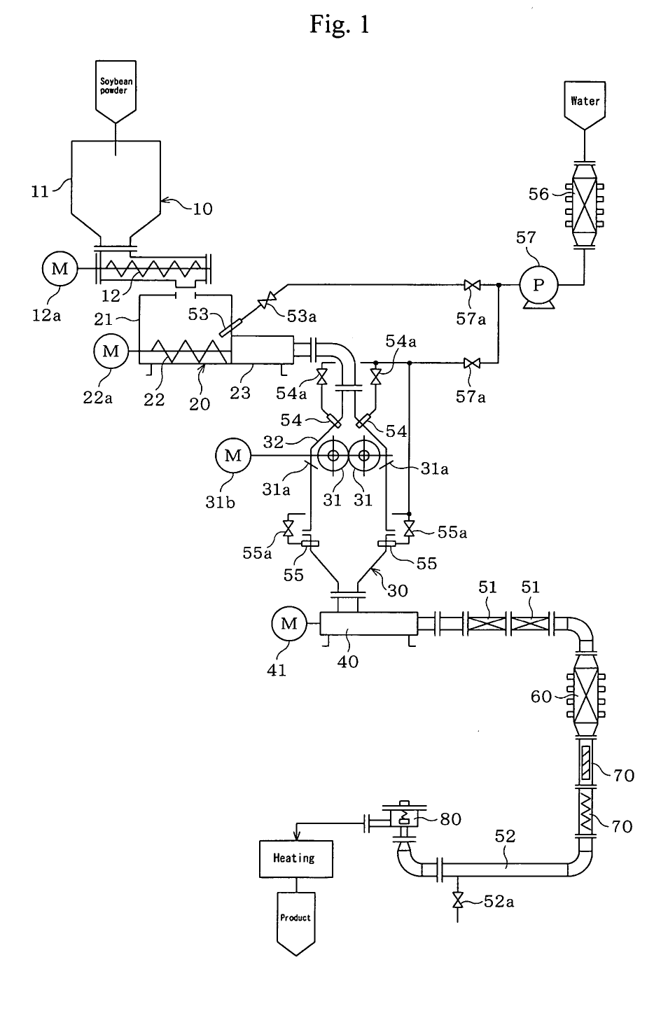

FIG. 2 shows constituents of the ultrasonic processing device 60 used in the production apparatus of soybean products of this invention. FIG. 2 (A) shows the side view of the casing 61, FIG. 2 (B) shows the whole lateral sectional view, and FIG. 2 (C) shows the side view of the vibrating plate 62 loaded with the ultrasonic generators 63, 63 . . . .

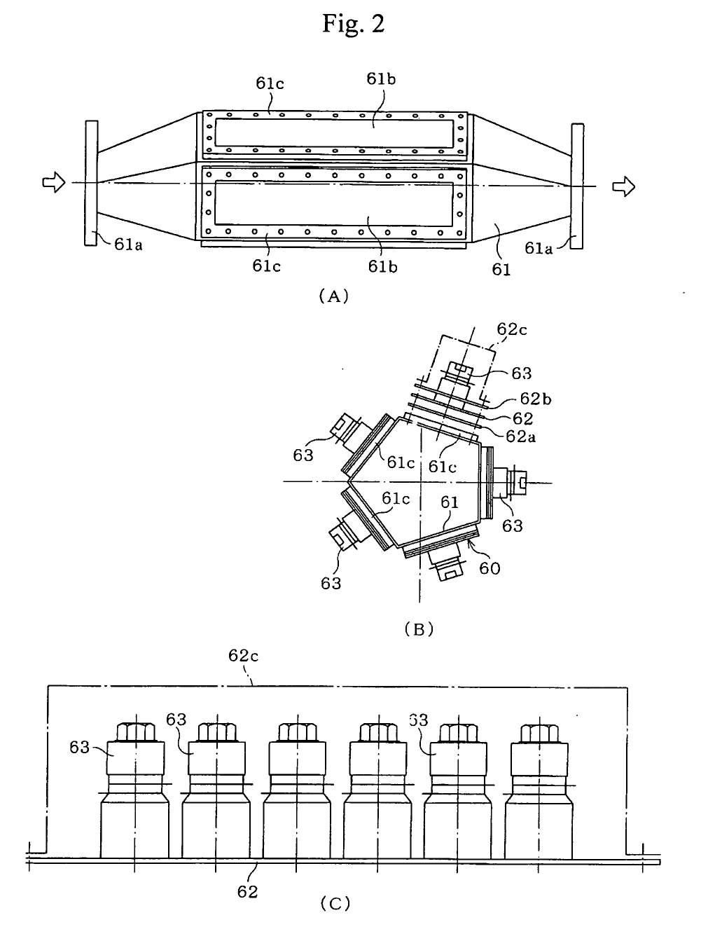

FIG. 3 shows the constitutional examples (A) to (D) of the labyrinth device 70 in the production apparatus of soybean products of this invention.

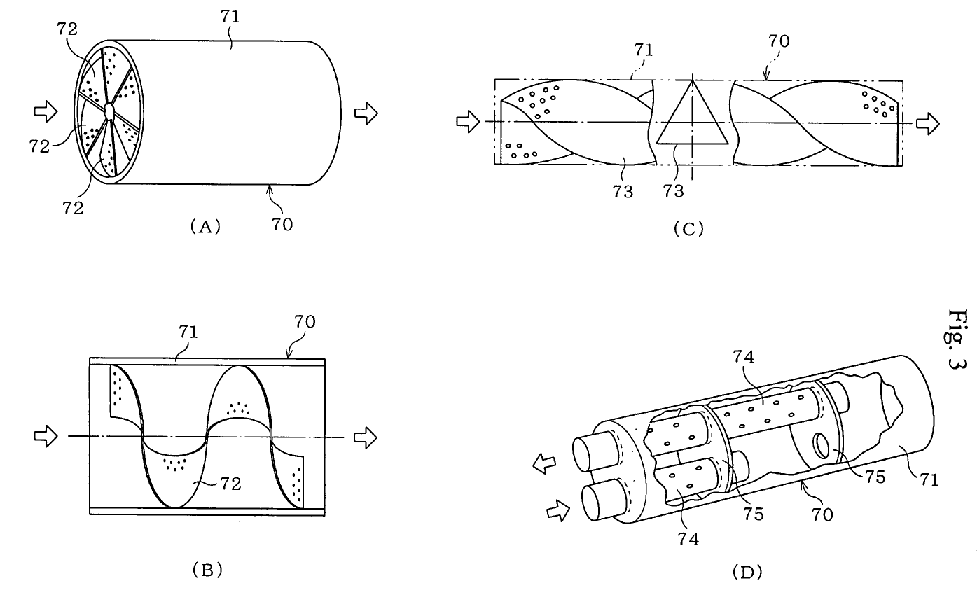

FIG. 4 shows a whole constitutional example of the pressure valve 80 in the production apparatus of soybean products of this invention.

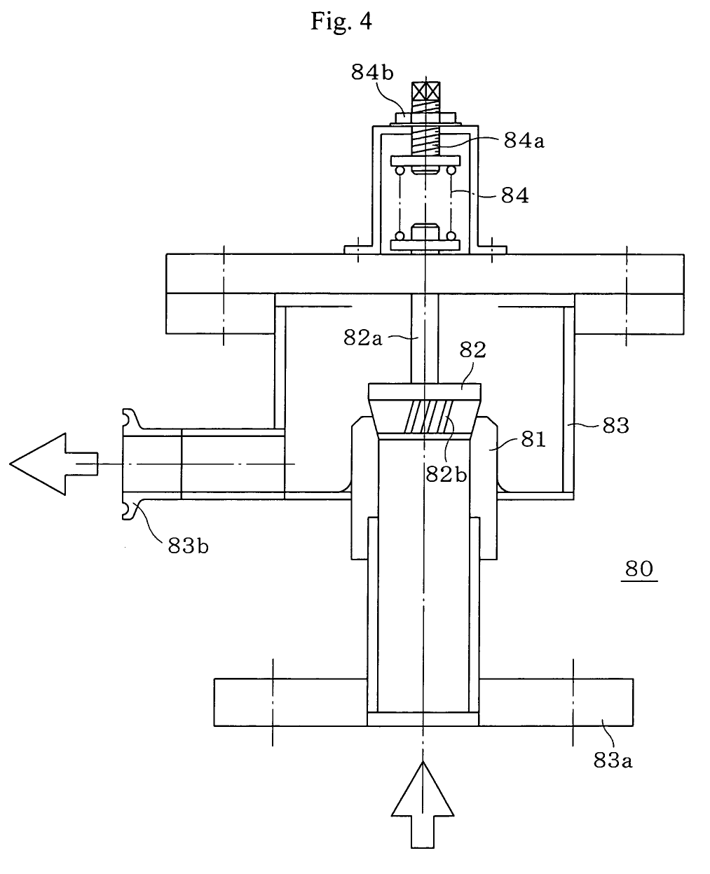

FIG. 5 shows a flowchart of the whole processing steps of the production method of soybean products of this invention.

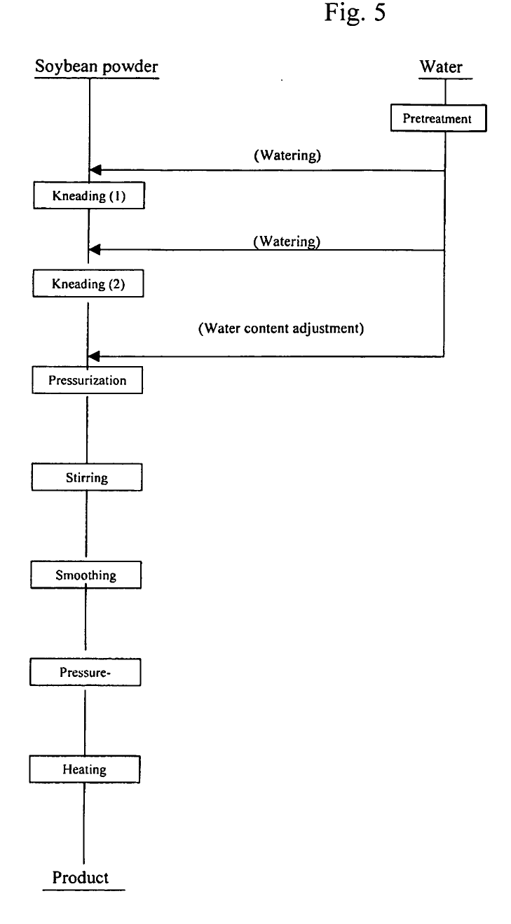

FIG. 6 shows the grain diameter distribution curve of the soybean paste of the embodiment of this invention and those of the soybean paste of the comparative examples (1) to (3).

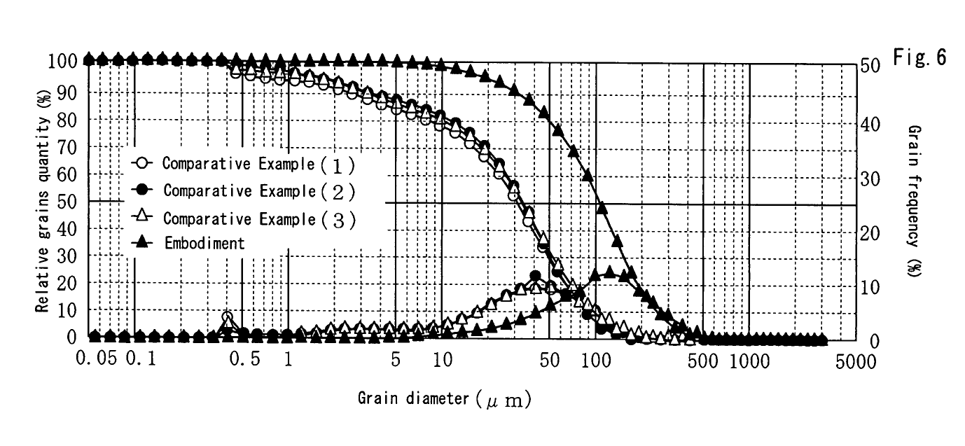

FIG. 7 shows the grain diameter distribution curve of the fine particles dispersed in the soybean paste of the embodiment of this invention.

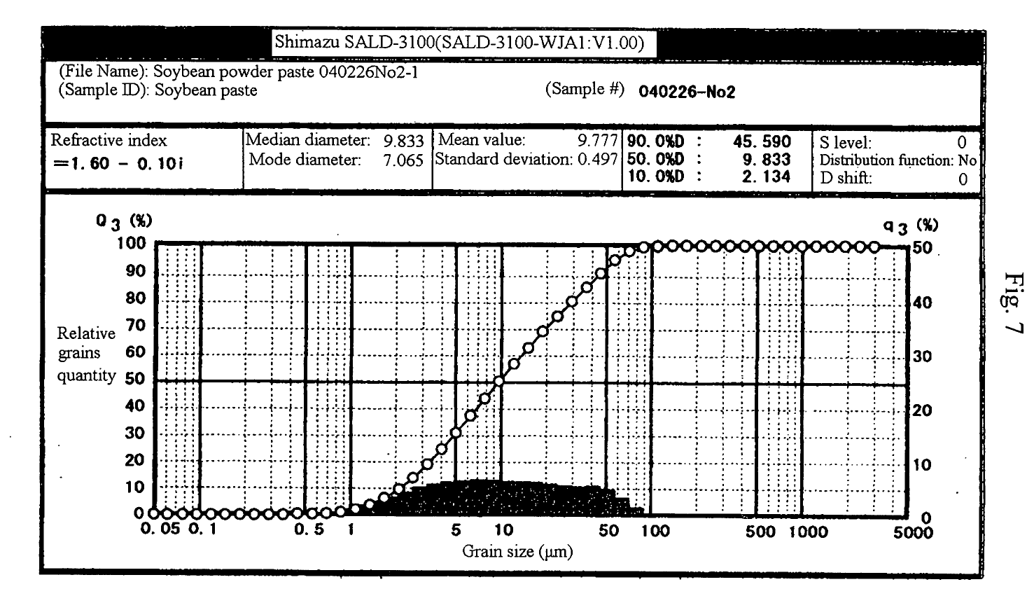

FIG. 8 gives data in tabular form of the mouthfeel evaluation tests of the soybean paste of the embodiment of this invention and those of the soybean paste of the comparative examples (1) to (3).

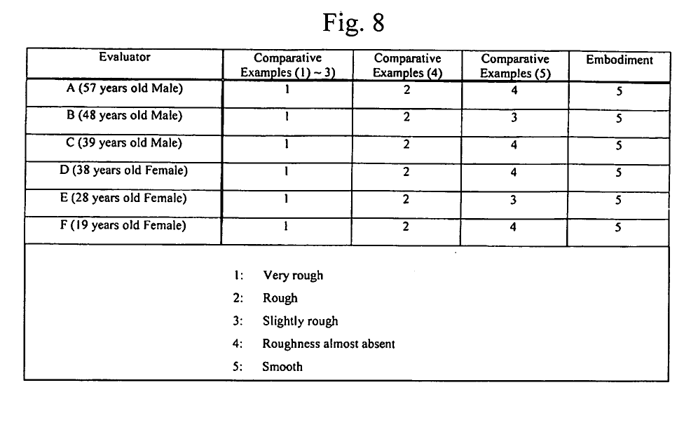

### EXPLANATION OF SYMBOLS

10 . . . Feeding device
11 . . . Hopper
12 . . . Screw conveyer
12a . . . Driving motor (for screw conveyer)
20 . . . Screw device
21 . . . Kneading chamber
22 . . . Kneading screw (kneading device)
22a . . . Driving motor (for kneading screw)
23 . . . Pump (for screw device)
30 . . . Roller device (kneading device)
31 . . . Kneading roller
31a . . . Scraper
31b . . . Driving motor
32 . . . Kneading chamber
40 . . . Pump (pressurization device)
41 . . . Driving motor (for pump)
51 . . . Static mixer (stirring device)
52 . . . Reservoir pipe
52a . . . Drain valve
53, 54, 55 . . . Water nozzles
53a, 54a, 55a . . . Flow rate adjusting valve
56 . . . Ultrasonic processing device (preprocessing device)
57 . . . Water supply pump
57a . . . Switch valve
60 . . . Ultrasonic processing device
61 . . . Casing
61a . . . Flange
61b . . . Opening
61c . . . Flange
62 . . . Vibrating plate
62a . . . Packing
62b . . . Holding box
62c . . . Cover
63 . . . Ultrasonic generator
70 . . . Labyrinth device
71 . . . Casing
72 . . . Guiding blades
73, 74 . . . Guide pipes
75 . . . Baffle plate
80 . . . Pressure valve
81 . . . Valve seat
82 . . . Valve body
82a . . . Valve rod
82b . . . Narrow groove
83 . . . Valve box
83a, 83b . . . Flanges
84 . . . Compression spring
84a . . . Holding clasp
84b . . . Lock nut

1. A continuous production method of soybean products, wherein a soybean blend obtained by adding water to soybean powder then kneading is pressurized and stirred under fixed pressure to adjust its water content, the soybean solid component present in the soybean blend is smoothed and the pressure applied on it is released.

2. The continuous production method of soybean products according to claim 1, wherein the pressure 50 kg/cm² or less is set for pressurizing the soybean blend.

3. The continuous production method of soybean products according to claim 1, wherein pressure in the soybean blend is released rapidly to atmospheric pressure.

4. The continuous production method of soybean products according to claim 1, wherein smoothing of the soybean solid component present in the soybean blend is carried out by passing the soybean blend through several fine pores provided in the flow path of the soybean blend.

5. The continuous production method of soybean products of according to claim 1, wherein smoothing of the soybean solid component present in the soybean blend is carried out in combination of ultrasonic processing.

6. The continuous production method of soybean products of according to claim 1, wherein the water used for watering the soybean powder and/or adjusting the water content of the soybean blend is pretreated to refine clusters of the water.

7. The continuous production method of soybean products of according to claim 1, wherein soymilk is produced by mixing equal amount of water with the soybean powders and at the time of its watering, about 6 to 25 times of water with respect to the quantity of soybean solid component in the soybean blend are added, then at the time of water adjustment in the soybean blend and then pressurizing the blend at the prescribed pressure 5 to 50 kg/cm².

8. The continuous production method of soybean products of according to claim 1, wherein a soybean paste is produced by mixing equal amount of water with the soybean powders at the time of its watering, about 2 to 5 times water with respect to the quantity of the soybean solid component in the soybean blend are added at the time of water adjustment in the soybean blend and then pressurizing the blend at the prescribed pressure 2 to 10 kg/cm².

9. A continuous production method of soybean products equipped with kneading means to knead watered soybean powder, a water content adjustment means to adjust the water content in the soybean blend coming from the kneading means, a pressurization means to pressurize the soybean blend after water-content adjustment at the prescribed pressure, processing systems to stir the pressurized soybean blend and smoothing of the soybean solid component in the soybean blend, and a pressure releasing means to release the pressure in the soybean blend coming from the processing systems to atmospheric pressure.

10. The continuous production method of soybean products according to claim 9, wherein the processing means is equipped with structures provided with multiple fine pores in casing and a labyrinth device to smooth the soybean solid component present in the soybean blend by passing it through the fine pores provided in the structures.

11. The continuous production method of soybean products according to claim 9, wherein the kneading means comprises a screw device and a roller device placed longitudinally.

12. The continuous production method of soybean products of according to claim 9, wherein the processing means includes an ultrasonic processing device.

13. The continuous production method of soybean products of according to claim 9, wherein a preprocessing device for refining clusters of the water used for watering the soybean powder and/or adjusting the water content of the soybean blend, is provided.
